(19) United States
(12) Patent Application Publication
(10) Pub. No.: US 2020/0327479 A1
(43) Pub. Date: Oct. 15, 2020

(54) Bidirectional Selecting System and Bidirectional Selecting Method between Service Objects and Service Providers

(71) Applicant: David & Raymond Patent Firm, Monterey Park, CA (US)

(72) Inventors: Raymond Y. CHAN, Monterey Park, CA (US); Rihui CHEN, Shenzhen (CN); Xueguang DONG, Shenzhen (CN); Tiaowan LIU, Shenzhen (CN); Wei DU, Shenzhen (CN); Xiaoxiao DUAN, Shenzhen (CN)

(73) Assignee: David & Raymond Patent Firm, Monterey Park, CA (US)

(21) Appl. No.: 16/796,919

(22) Filed: Feb. 20, 2020

(30) Foreign Application Priority Data
Feb. 20, 2019 (CN) 2019101263083

(51) Int. Cl. G06Q 10/06; G06Q 30/06

(52) U.S. Cl. CPC G06Q 10/063112; G06Q 10/1053; G06Q 30/0619

(57) ABSTRACT

A bidirectional selecting method, between service objects and service providers, includes the steps of:
after acquiring an expression data about a user, acquiring at least intentional object in a corresponding object database based on the expression data and a background information of the user to obtain a processing result; and
outputting the processing result, wherein when the user is a service object, the object database is a service provider database, wherein when the user is a service provider, the object database is a service object database.

### CROSS REFERENCE OF RELATED APPLICATION

This is a non-provisional application that claims the benefit of priority under 35 U.S.C. § 119(a-d) to a Chinese application, application number 2019101263083, filed Feb. 20, 2019.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to services field, especially to a bidirectional selecting system and bidirectional selecting method between service objects and service providers.

### Description of Related Arts

There are problems faced by the user when seeking some professional services. One of the problems is professional barriers caused by asymmetric information. For example, intellectual property is becoming more deeply correlative in daily live and work. With the intensification of commercial competition, intellectual property has become a very favorable and convenient competitive tool which can prevent competitors entering the exclusive rights. Patent is one type of intellectual property. With rising applications in China, more and more companies go overseas for patent applications, so that their products can be under patent protection in other countries to avoid being plagiarized or copied.

Patent is a document in legal language to express technology which has highly requirement for patent drafters. Once there is loopholes or unnecessary limitations in claims because of losing profound understanding, it will make the power of the patent itself greatly reduced, or even has adverse effect. For example, some technique details are described in the embodiments and not claimed for protection, which will be voluntary contribution of the inventor for the public based on the principle of donation in patent. Therefore, in order to better protection, customers need to communicate with patent agents to assign patent application and buy professional services of the patent agency to get high-quality patent applications and patent application process.

In the conventional service mode of the patent agency, the communication between the customer and patent agents goes like, firstly providing the customer quotes, then if the price is acceptable, negotiating for further information, after both agreed and signed a contract, sending a technical disclosure from customer to patent agent, and writing of the patent by a patent engineer. A patent engineer refers to a professional practitioner who can specifically deal with patent-related matters. For example, a patent engineer can draft a specification about the technical disclosure under the Patent Law of the People's Republic of China, Chinese Patent Law Implementation Rules and Examination Guide of National Intellectual Property Administration, PRC or under Patent Laws and Patent Rules of United States.

Clearly, in this process, the customer knows little about the patent engineers who actually drafted the case. Customer even has no idea about whether the patent engineers drafting the case have enough experience or not, or whether have experience in this field. For customers who really want to protect their inventions, this process can hardly achieve a satisfactory level.

After drafted specification is sent to be check by customers, if the quality of the specification did not meet the requirements of the customers, during this stage, the customers ask to change another drafter. And if the patent agent takes remedies to rewrite the specification, the time cost of the case has been generated. Especially for the patent application, the filing date has the importance of self-evident.

Not only in intellectual property, but other highly specialized industry is the same. There is a Chinses saying that “different trades are separated as by mountains”. How to reduce the asymmetric information in the process, and give customer greater autonomy rights, is an urgent problem for customer and for professional services providers.

### SUMMARY OF THE PRESENT INVENTION

The invention is advantageous in that it provides a bidirectional selecting system and bidirectional selecting method between service objects and service providers, wherein the service objects are capable of selecting the service provider by the system.

Another advantage of the invention is to provide a bidirectional selecting system and bidirectional selecting method between service objects and service providers, wherein the service providers can be screened for the server objects according to the needs by the system.

Another advantage of the invention is to provide a bidirectional selecting system and bidirectional selecting method between service objects and service providers, wherein the service objects can choose the service provider by the system.

Another advantage of the invention is to provide a bidirectional selecting system and bidirectional selecting method between service objects and service providers, wherein the service objects are capable of selecting the service provider from an object database according to the background of the service providers.

Another advantage of the invention is to provide a bidirectional selecting system and bidirectional selecting method between service objects and service providers, wherein the service providers can be automatically recommended to the server objects according to the needs of the server objects.

Another advantage of the invention is to provide a bidirectional selecting system and bidirectional selecting method between service objects and service providers, wherein the service object can directly communicate with the service provider to arrange scheduled tasks by the system.

Another advantage of the invention is to provide a bidirectional selecting system and bidirectional selecting method between service objects and service providers, wherein the service provider can do easily working arrangements by the system.

Another advantage of the invention is to provide a bidirectional selecting system and bidirectional selecting method between service objects and service providers, wherein the service object is capable of knowing the progress of the service provider corresponding to the service by the system.

Another advantage of the invention is to provide a bidirectional selecting system and bidirectional selecting method between service objects and service providers, wherein the service object can screen the service provider under plurality of conditions by the system.

Another advantage of the invention is to provide a bidirectional selecting system and bidirectional selecting method between service objects and service providers, wherein tasks of the service object can be expedited by the system.

Another advantage of the invention is to provide a bidirectional selecting system and bidirectional selecting method between service objects and service providers, wherein the service provider can expeditedly deal with corresponding tasks by the system.

Additional advantages and features of the invention will become apparent from the description which follows, and may be realized by means of the instrumentalities and combinations particular point out in the appended claims.

According to the present invention, the foregoing and other objects and advantages are attained by a bidirectional selecting method between service objects and service providers, which comprises the steps of:

after acquiring an expression data about a user, acquiring at least intentional object in a corresponding object database based on the expression data and a background information of the user to obtain a processing result; and

outputting the processing result, wherein when the user is a service object, the object database is a service provider database, wherein when the user is a service provider, the object database is a service object database.

In one embodiment, in the method, after acquiring the expression data of the user, matching the expression data with the conditions inside the background information of the user in the object database.

In one embodiment, the bidirectional selecting method further comprises the steps of:

after acquiring the expression data of the user, matching the expression data with the conditions inside the background information of the user in the object database; and

if no intentional object is matched, recommending at least one object in the object database as the intentional object based on the background information of the user.

In one embodiment, the bidirectional selecting method further comprises the steps of:

After acquiring the expression data of the user, matching the expression data and the conditions included in the background information of the user in the object database; and

if no intentional object is matched, recommending at least one object in the object database as the intentional object based on a behavior information of the user.

In one embodiment, the bidirectional selecting method further comprises the steps of:

obtaining a determined order from the user to confirm that the intentional object is a intentional object.

In one embodiment, the method, when the user is a service object and the intentional object is the service provider, further comprises determining whether there is an object with only the deadline of the task is not met and the object is capable of completing the task within the deadline; and

if so, generating a prompt information, wherein the prompt information and the object are output as the processing result.

In one embodiment, the method, when the user is a service object and the intentional object is a service provider, further comprises determining whether there is an object with only the deadline of the task is not met but is available for expedited task and the object is capable of completing the task within the deadline; and

if so, generating a prompt information, wherein the prompt information and the object are output as the processing result.

In one embodiment, the bidirectional selecting method further comprises the steps of:

if the intentional object is not matched, obtaining the behavior data of the user;

generating an intentional prediction result based on the behavior data;

recommending at least one object in the object database is as the intentional object, based on the intentional prediction result.

In one embodiment, in above method, determining whether the object is capable of providing the expedited service in a manner that obtaining the information of the expedited service predetermined by the service provider.

In one embodiment, in above method, determining whether the object is capable of providing the expedited service in a manner that obtaining a working arrangement of the object which only not comply with the mandate.

In one embodiment, in the method, determining whether the object is capable of providing the expedited service in a manner that sending a query to the corresponding object and considering the reply of the object.

According to the present invention, the foregoing and other objects and advantages are attained by a bidirectional selecting system for a service object and a service provider, comprising:

an acquiring unit, wherein the acquiring unit is configured to acquire an expression data and a background information of a user;

a processing unit, wherein the processing unit is communicatively connected with the acquiring unit, wherein the processing unit is configured to have at least one intentional object to obtain a processing result based on an object database with the expression data and the background information of the user; and

an output unit, wherein the output unit is communicably coupled to the processing unit, wherein the output unit outputs the processing result including the intentional object, wherein when the user is service object, the object database is a service provider database, wherein when the user is a service provider, the object database is a service object database.

In one embodiment, the system further comprises a determining unit, wherein the determining unit is communicatively connected with the processing unit, wherein the determining unit confirms the object as a intentional object of the user based on a feedback order corresponding to the processing result.

In one embodiment, the processing unit comprises an analysis module and a matching module, wherein the analysis module obtains at least one condition based on the analyzed expression data, wherein the matching module matches the object in the object database based on the condition.

In one embodiment, the processing unit further comprises a recommendation module, wherein recommendation module is communicatively connected with the matching module, wherein when the matching module has not matched an object in the object database, the recommendation module screens at least one object to obtain a recommendation result based on the expression data of the user according to a predetermined rule in the object database, wherein the recommendation result is output by the output unit.

In one embodiment, the recommendation module screens in the object database in a manner that reducing the number of the conditions or reducing the condition.

In one embodiment, the acquiring unit comprises an acquiring user request module, an acquiring user background module and an acquiring user behavior module, wherein the processing unit is communicatively connected respectively to the acquiring user request module, the acquiring user background module and the acquiring user behavior module, wherein the processing unit comprises a recommendation module, wherein the recommendation module is communicably connected with the acquiring user behavior module, wherein the recommendation module recommends at least one intentional object from the object database based on a behavior data acquired by the acquiring user behavior module

In one embodiment, the processing unit further comprises an analysis module and a matching module, wherein the analysis module obtains at least one condition based on the analyzed expression data, wherein the matching module matches the object in the object database based on the condition, wherein the matching module matches the object based on the object database including the condition, wherein when the matching module has not match the object in the object database, the recommendation module recommends at least one of the intentional object from the object database based on a behavior data acquired by the acquiring user behavior module.

In one embodiment, the processing unit further comprises a judgement module and a re-judgement module, wherein when the matching module has not match the object in the object database, the judgement module determines whether there is an object with only the deadline of the task is not met, if so, the re judgement module determines whether the object who not met the deadline is capable of providing an expedited service and whether is capable of finishing the case in time, if so, the output unit outputs the object.

In one embodiment, the system further comprises an interactive unit, wherein the interactive unit is communicatively connected with the processing unit and the output unit, wherein the interactive unit is allowed communication between the user and the object.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a flow chart perspective view of a bidirectional selecting method between the service objects and the service providers according to a preferred embodiment of the present invention.

FIG. 2 is a block diagram of a bidirectional selecting system between the service objects and the service providers according to a preferred embodiment of the present invention.

FIG. 3A is a schematic view of using a bidirectional selecting method between the service objects and the service providers according to a preferred embodiment of the present invention.

FIG. 3B is a schematic view of using a bidirectional selecting method between the service objects and the service providers according to a preferred embodiment of the present invention.

FIG. 4A is a schematic view of using a bidirectional selecting method between the service objects and the service providers according to a preferred embodiment of the present invention.

FIG. 4B is a schematic view of using a bidirectional selecting method between the service objects and the service providers according to a preferred embodiment of the present invention.

FIG. 4C is a schematic view of using a bidirectional selecting method between the service objects and the service providers according to a preferred embodiment of the present invention.

FIG. 4D is a schematic view of using a bidirectional selecting method between the service objects and the service providers according to a preferred embodiment of the present invention.

FIG. 5A is a schematic view of using a bidirectional selecting method between the service objects and the service providers according to a preferred embodiment of the present invention.

FIG. 5B is a schematic view of using a bidirectional selecting method between the service objects and the service providers according to a preferred embodiment of the present invention.

FIG. 6A is a schematic view of using a bidirectional selecting method between the service objects and the service providers according to a preferred embodiment of the present invention.

FIG. 6B is a schematic view of using a bidirectional selecting method between the service objects and the service providers according to a preferred embodiment of the present invention.

FIG. 7 is a block diagram of using a computer system according to a preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

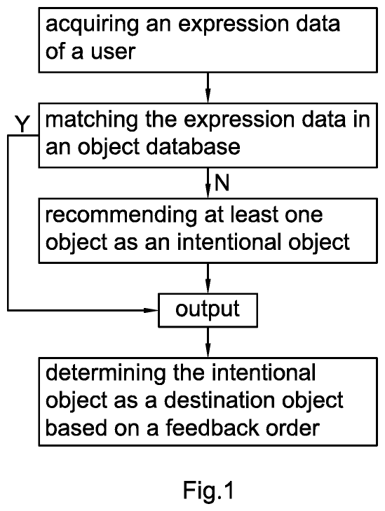

As shown in FIG. 1, a bidirectional selecting method between the service objects and the service providers according to a preferred embodiment of the present invention is illustrated.

The bidirectional selecting method 1 can select the service provider based on the service object, and also can select the service object based on the service provider. A user can select at least one intentional object through a managing system. The user can be the service object, and the intentional object is the service provider. The user may also be the service provider, and the intentional object is the service object.

Furthermore, the service object can actively screened based on their demand for screening the service providers and can also passively provide information to provide screening of the service providers.

The service provider can actively screened based on their demand for screening the service object and can also passively provide information to provide screening of the service providers.

The bidirectional selecting method 1 between the service objects and the service providers comprises the following steps of:

after obtaining an expression data about a user, acquiring at least one intentional object to obtain a processing result from a corresponding object database based on the expression data and a background information of the user; and

outputting the processing result, wherein when the user is a service object, the object database is a service provider database, wherein when the user is a service provider, the object database is a service provider database.

It will be understand that the expression data can be expressed by an input device from the user, and can comprises a user request.

Furthermore, the bidirectional selecting method 1 comprises the following steps of:

if no intentional object is matched, recommending at least one object in the object database as the intentional object.

In one embodiment, the bidirectional selecting method 1 is implemented as:

obtaining at least one intentional object to obtain the processing result from the object database based on the expression data and a background information of a user.

In one embodiment, in the above method, when the expression data cannot be matched to the intentional object, at least one intentional object is obtained as the processing result from the object database based on the expression data and the background information of the user.

The background information of the user may be a name of the user, or a history of the user. The name of the user is associated with the user's company which is capable of understanding the field of the company and inferring the user's intentional object.

In the present embodiment, the user is a service object, and the service provider is a patent engineer. Of course, it can be understood that the description herein is merely illustrative, and the types of the service provider and the service object are not limited thereto.

With the bidirectional selecting method 1, the user can find qualified patent engineer. On the one hand, the user has a larger right to choose for assigned cases according to their needs. On the other hand, the user can timely know the progress of the case. For the user, the service quality will be greatly improved. For the patent firm, there is not required as in the conventional manner according to the real-time organization which each case individually be dispatched to the patent engineers according to what they are drafting, which is greatly enhanced the efficiency of dispatching. For patent engineers, it can help scientifically and orderly to plan their working hours for the cases.

Specifically, the bidirectional selecting method 1 between the service objects and the service providers comprises the steps of:

matching at least one engineer who meets the condition with a user request as a condition in an engineer database and outputting a matching result; and

determining at least one engineer as one of the intentional objects based on a feedback determined order to pair the intentional objects with the user, wherein the feedback determined order is based on the matching result. The intentional object processes the task of the user based on the selection of the user.

In detail, the user request can be selected from one or more of case fee, case quality, and case deadline. The costs, quality and duration of cases are undoubtedly the most concerned about for the user. The cost of the case refers to a single invention or utility model fees. The duration of the case refers to a certain date when the case completed.

The quality of the case is proportional to the cost of the case. For example, in a patent firm, there is a patent engineer A, a patent engineer B, a patent engineer C, and a patent engineer D, wherein the patent engineer A is an expert engineer, and the patent engineer B is a senior engineer, and the patent engineer C is an advance engineer, and the patent engineer D is the primary engineer. Each of patented engineers has the different levels, and the level of each of the patent engineer changes from primary, advance, senior to expert step by step. Patent engineer's level means the quality of patent drafting, and patent drafting also represents the cost of drafting, and with the higher level of patent engineers, the higher quality of patent drafting, and the higher cost of patent drafting.

The user can input his or her own needs through an input device. And then a processor receives the user request and associates a memory storing a patent engineer database for processing the user request, and outputs a processing result through an output device. The input device can be a mouse or a keyboard or a touch screen, and the output device can be a display screen or a speaker.

The user input their needs through the input device, and the needs of the user transmitted from the user are processed in the processor. Base on the user request as conditions, the processor screens in the patent engineer database provided by the storage to generate a screening result. The screening result is sent to the output device and output by the output device. The user obtains the screening result through the output device. Through the input device, the user may send a feedback order. The feedback order may be to confirm the patent engineer based on the screening result, or may perform re-screening to find the patent engineers who meets user needs according to the screening result.

For example, the user may input the needs by the input device, such as a cost. The processor retrieves the patent databases based on the cost to obtain a patent engineer matched with the cost. It will be understand that the user input needs through the input device which may input according to a prompt information given by a output device from the processor, or may input according to needs of the user.

Specifically, the user can directly enter the numerical value of the cost, and then waits for the feedback of the output device. May be the user enter or select the range of the cost or level of cost in the patent engineer database provided by the output device.

Furthermore, according to the embodiment, the bidirectional selecting method between the service objects and the service providers comprises the steps of:

determining whether there is at least one of the patent engineers in the patent engineer database that meets the user request; and

If so, outputting by the patent engineer as the screening result.

Specifically, when the processor retrieves there is a relevant patent engineer met the user request in the storage, the processor generates the screening result with the patent engineer and provides the screening result for the user by the output device.

For example, the user request comprises the screening result which is senior engineer and deadline is Dec. 31, 2018. There is one senior engineer and the schedule is available from November 2018, the senior engineer A, who meets the needs of the user in the patent engineer database. The senior engineer A is output as the screening result. The user can confirm the patent engineer A through the input device to realize communication between the user and the patent engineer A.

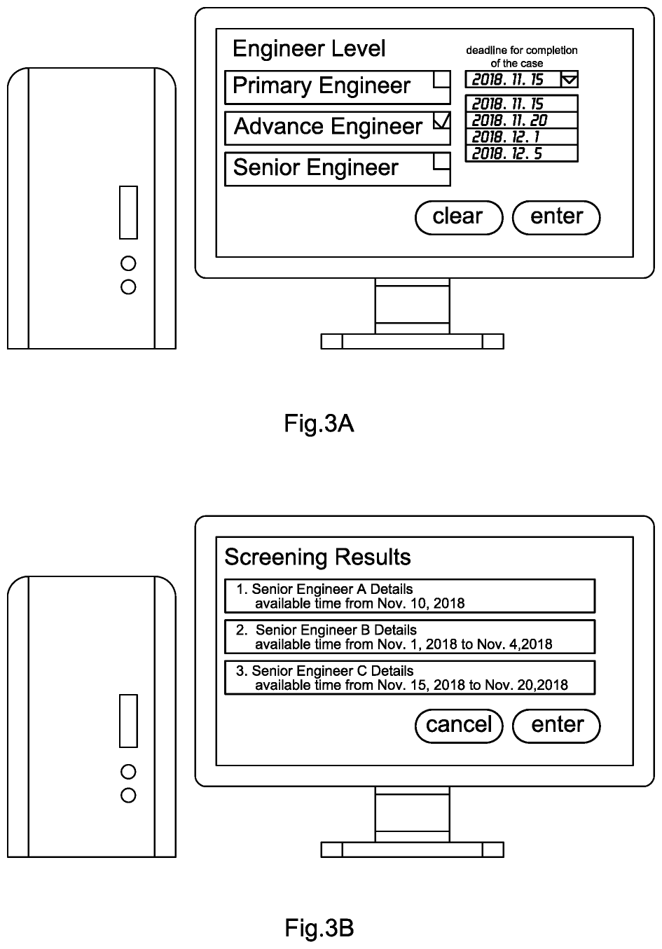

Furthermore, in the bidirectional selecting method 1 between the service objects and the service providers, when the number of the patent engineers is plural, the feedback order is based on a selection order of a plurality of the patent engineers, as shown in FIGS. 3A-3B.

For example, the screen conditions comprise the user request sent by the user, which is a senior engineer and deadline is Jan. 30, 2019. The processor retrieves in the patent engineer database and fines several engineers. One advance engineer A, available time is after Nov. 10, 2018. One senior engineer B, available time from Nov. 1, 2018 to Nov. 4, 2018. One senior engineer C, available time from Nov. 15, 2018 to Nov. 20, 2018.

In other words, there are a plurality of the patent engineers meet the needs of the user, and the screening result is feedback to the user by the output device. The user can select via the input device based on the screening result to confirm the selection the patent engineer as a communication object. For example, when the user wishes to complete as soon as possible, the Senior Engineer B may be selected as communication object. The processor via the input device receives a command to confirm the selection a patent engineer to communicate with the user.

It will be understood that the patent engineer in the screening result can comprises the basic information of patent engineer, for example, name, work experience, field of expertise, history of the case and so on, which helps the user to make a choice. Of course, the information may be used as screen conditions for determining the patent engineer.

For example, when the user request comprises a condition requiring the patent engineer experience is more than five years, matching the patent engineer with the condition in the patent engineer database. The matching result obtains a plurality of the patent engineers satisfied the condition and the matched result to the user, and the user can re-send the user request for retrieval of other ranges, for example, to retrieve a smaller range. The user may increase the number of conditions to narrow down the matching results to have less patent engineers so that the matching results are more streamlined. For example, increasing the deadline of the case, and re-matching the matching results. The bidirectional selecting method 1 between the service objects and the service providers, when the number of the patent engineers in the screening result is plural, further comprises the following steps of:

receiving a user request as a screening condition to find a new patent engineer in the screening result matched with the new screening condition and outputting the new screening result.

Specifically, when a plurality of the patent engineers to meet user needs, the screening result is feedback to the user by the output device. The user can narrow the scope of the screening based on preceding screening to screen again. The processor is based on the screen conditions for re-screening of the screening results and regains the new screening result which is feedback to the user via the output device. The user generates a feedback order based on the new screening results and the processor determines the patent engineer met the condition based on the feedback order.

For example, the processor receives the user request by the input device, which needs to meet the conditions of: primary engineer, deadline before February 2019. The screening result including dozens of patent engineers to meet the needs. The user has no needs to check every background information or details of each of the patent engineer one by one, only needs to re-enter the screen conditions by the input devices based on the screening results, such as further defined deadline in January, 2019 to narrow down.

The user may add more stringent conditions for the same kind screening condition, or add new kind screening condition. For example, adding a screening condition based on the background of the case, which means the patent engineer has experience in same field.

Of course, it will be understood that the user can completely replace the screening conditions and the processor re-searches.

When the user has experienced with patent agents, and is familiar with the patent agency, and is satisfied with the patent engineers often working together, it is possible to screen the name of the patent engineer directly as the screening condition. And finding whether the time schedule of the patent engineer provided by the output device by the output device can meet the requirement.

Furthermore, according to the embodiment, the bidirectional selecting method 1 between the service objects and the service providers comprises the following steps:

determining whether there is at least one patent engineer in the patent engineer database that meets the user request; and

if not, and when the screening conditions are multiple, reducing the screening conditions to rescreen for the screening result.

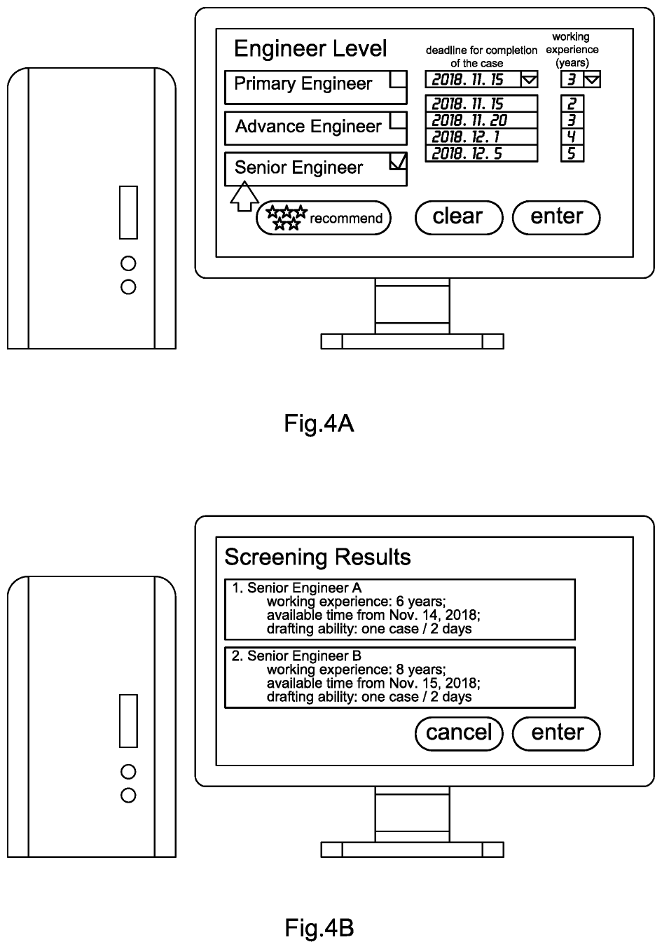

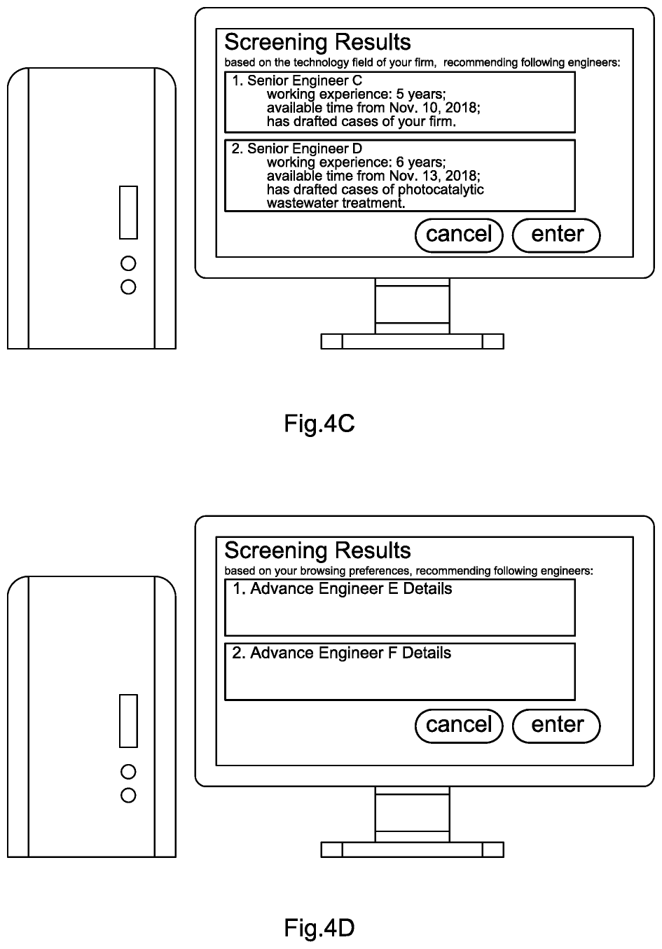

As shown in FIGS. 4A and 4B, specifically, when the user inputs the user request through the input device, the processor screens in patent engineer database to find the qualified engineers patent based on the screening conditions which has the user request, and when there is no the patent engineer met the screening conditions, the processor reduce at least one of the screening conditions to rescreen until the patent engineer meets the new screening conditions. The screening results is feedback to the user by the output device for the user. The user can select to rescreen or determine the patent engineer based on the screening results. In this way, more choices can be provide to the user.

For example, the user inputs the user request by the input device, and the user request includes: senior engineer, work experience for more than five years, and deadline is Nov. 15, 2018.

The processor did not find the patent engineers met the screening conditions in the first screening. The processor downgrades the screening conditions. For example, reducing one of the screening conditions, like screening with senior engineer and work experience for more than five years, not with deadline is Nov. 15, 2018, to find a senior engineer A and a senior engineer B. The senior engineer A has working experience for six years, and available time is after Nov. 14, 2018, and drafting ability is one case/2 days. If this one patent engineer is chose, and the deadline for the case is 16, November 2018. The senior engineer B has working experience for eight years, and available time is after Nov. 15, 2018, and drafting ability is one case/2 days. If this one patent engineer is chose, and the deadline for the case is Nov. 17, 2018.

The screen conditions are senior engineer and deadline is 15, November 2018, not with the condition of wording experience. The screening results are a senior engineer C and a senior engineer D, wherein the senior engineer C has available time form Nov. 1, 2018 and wording experience is 4 years and 10 months, wherein the senior engineer D has available time form Oct. 30, 2018 and wording experience is 4 years and 11 months.

The screen conditions are wording experience and deadline is 15, November 2018, not with the condition of senior engineer. The screening results are a advance engineer E and an expert engineer F, wherein the advance engineer E has available time form Nov. 1, 2018 and wording experience is 6 years, wherein the expert engineer F has available time form Nov. 10, 2018 and wording experience is 8 years.

Above screening results are output through the output device to the user, and the user can select or rescreen based on the screening results. In this way, the user is given multiple choices and the user is able to rethink the screening condition. If the user take seriously on senior engineer and working experience, and deadline within a day or two is not very concerned about, so the user can choose the senior engineer A and the senior engineer B. If the user take seriously on senior engineer and deadline, and working experience is not very concerned about, so the user can choose the senior engineer C and the senior engineer D. If the user take seriously on working experience and deadline, and senior engineer is not very concerned about, so the user can choose the senior engineer E and the senior engineer F.

Of course, it is understandable that one of the cases of the user may have one of the patent engineers, or may have more than one patent engineers. In other words, one case can be drafted by several patent engineers independently, or drafted co-authoredly.

According to the embodiment of the invention, the bidirectional selecting method 1 between the service objects and the service providers further comprises the following steps:

determining whether there is at least one of the patent engineer met the user request in the patent engineer database; and

if not, and the screening condition that does not meet is the deadline, generating a screening result.

Specifically, the user request comprises a plurality of the screening conditions, and one of the screening conditions is deadline. The processor matches in the patent engineer database based on the plurality of the screening conditions. When there is no the patent engineer in the patent engineer database met all the screening conditions, and there is the patent engineer only not met the deadline of the screening conditions, the patent engineer only not met the deadline outputs as the screening result through the output device.

Furthermore, the bidirectional selecting method 1 may also recommend the intentional object based on other manners.

The bidirectional selecting method 1 may further comprises the following steps of:

After obtaining the expression data of the user, matching the conditions included inside the expression data and the background information of the user in the object database; and

If no intentional object is matched, recommending at least one object in the object database as the intentional object based on the background information of the user.

As shown in FIG. 4C, for example, the user request input through the input device by the user comprises: senior engineer, working experience: more than five years, and deadline is Nov. 11, 2018. According to the user request, the screening result is 0 in the engineer database. And the background information of the user includes drafted cases of photocatalytic wastewater treatment. Other engineers may be to recommend to the user, such as a senior engineer C, working experience: 5 years, available time from Nov. 11, 2018, has drafted cases of your firm. A senior engineer D, working experience: 6 years, available time from Nov. 13, 2018, has drafted cases of photocatalytic wastewater treatment. Based on the user's background information, the senior engineer C and the senior engineer D may be the intentional object of the user. The user may select an intentional object based on the recommendation selection.

Furthermore, the bidirectional selecting method 1 comprises the following steps of:

After acquiring the expression data of the user, matching the condition included in the expression data and in the background information of the user in the object database; and

If there is no match to intentional object, recommending at least one object as the intentional object in the object database based on the behavior data of the user.

The behavior data of the user may be the user's click behavior, time on page, screening conditions and so on. These behavior of user may reflect the user's preferences and may be used to recommend the objects that may be intentional for the user.

For example, as shown in FIG. 4D, the user stays a longer time to the page of the advance engineer E, then the advance engineer E and F can be recommended based on the user behavior data, wherein the background information of the advance engineer E is similar with the advance engineer F.

Furthermore, further screening in the patent engineer database is allowable based on the expression data of the user. But if there is not any the object met the conditions, then make recommendations based on the behavior data of the user to satisfy as far as possible the user.

The bidirectional selecting method 1 may further comprises the following steps of:

if the intentional object is not matched, acquiring the behavior data of the user;

generating an intentional prediction result based on the behavior data; and

recommending at least one object in the object database as the intentional object, based on the intentional prediction result.

For example, based on the residence time of the mouse of the user, the residence position and the refresh time, generating the intentional prediction result. For example, the user can copy a history case of the patent engineer, which is able to know that the user is interesting with the patent engineer had drafted the case or the field.

Furthermore, the selecting method comprises the following steps of:

determining whether there is a patent engineer with only the deadline not met can provide expedited task; and

if so, generating a prompt information, wherein the prompt information is output as at least part of the feedback result.

If there is no patent engineer matched, determining whether there is a patent engineer who only does not meet the deadline or not;

if so, determining whether there is a patent engineer with only the deadline not met can provide expedited task; and

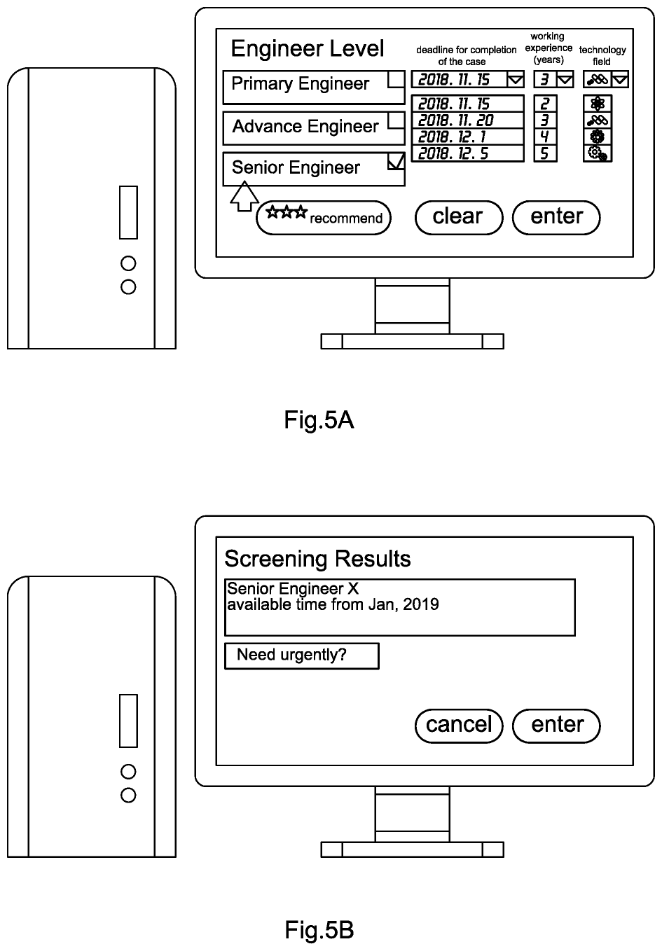

if so, generating a prompt information, wherein the prompt information is output as at least part of the feedback result. The specific description will be made as following in FIGS. 5A-5B.

The patent engineer may provide the expedited service which means process the user's case in advance to satisfy user requirements. The patent engineers can provide patent services outside normal working hours, such as after business hours from work. The patented engineer provides drafting services for the expedited service to complete the writing of the case to meet the expedited needs of the user.

For example, when the user has a deadline tantalizing case needed a assigned patent engineer to process, the user found that the patent engineer has full schedule but the patented engineer can provide expedited service, so the user can pay for expedited fee to make the patent engineers preferred to deal with this case and not affect others cases.

The patent engineer also can provide expedited service in the normal working hours, which needs pre-arranged cases to be drafted later, so that requires expedited service of the user of the case can jump the queue to be processed. For example, when the user has a deadline tantalizing case needed a assigned patent engineer to process, the user found that the patent engineer has full schedule but the patent engineer can draft pre-arranged cases later. So the user can pay for expedited fee to make the patent engineers preferred to deal with this case, and it may cause influence to other cases, but it is acceptable and has no affect the needs of the user corresponding to other cases.

Furthermore, in the present invention, in some embodiments, determining whether the patent engineer can provide expedited service or not in a manner that obtaining the deadline of the case is matched with a working arranging style of patent engineer.

For example, the user needs a senior engineer, who has background of pharmaceutical field, 5 or more years of working experience, and the case deadline is December, 2018. It is not fully matched with any engineers with the user request, and only one senior engineer deal with the background of the case is the pharmaceutical field, and have 5 years or more experience, but his available time from January, 2019.

Obtaining the working arranging of the senior engineer, and there is at least one case pre-arranged before January, 2019 can be delayed to after January, 2019. So in the objective, the senior engineer can provide expedited service for the user.

Then generating the prompt information which comprises that the senior engineers can provide the expedited service, and the cost of expedited service. The user can select to decide to purchase this service based on the prompt information, or change the screening conditions to screen for other patent engineer.

It can be understood that, in the method, before the generating the prompt information, an advisory opinion may be sent to the patent engineer to confirm whether the patent engineer is willing to provide the expedited service, which means to accept the user's case to jump in the queue. If so, generating the prompt information which comprises the opinion of the patent engineer.

Of course, it may be that the patent engineer has pre-set whether or not willing to provide the expedited service. If so, the user can directly select in the subsequent steps.

Furthermore, in some embodiments of the present invention, the selecting method determines whether the patent engineer can provide expedited service in a manner that obtaining a predetermined expedited service information.

In details, the patent engineers set the expedited service information in advance, such as that the expedited service may be cut in line during normal working hours, or the expedited service may be outside working hours. The patent engineer can pre-set what kind of service is willing to provide.

For example, the patent engineer not wanted to work overtime can select to set provide normal working time within the cut in lines. Willing to work overtime ones can select to set provide both outside of normal working hours and normal working time within the cut in lines

If the method got to the patent engineers are willing to provide the expedited service within normal time, determining whether the patent engineer with current working arrangements can complete within the time limit. If can, the prompt information is generated to prompt the user to select the patent engineer to provide an expedited service. If can not, the user may request to recommend other patent engineers that may satisfy the user request.

If the method got to the patent engineers are willing to provide the expedited service within normal time, determining whether the patent engineer with current working arrangements can complete within the time limit. If can, the prompt information is generated to prompt the user to select the patent engineer to provide an expedited service and offer the fee of expedited service. If cannot, the user may request to recommend other patent engineers that may satisfy the user request.

More specifically, for example, if the method got to the patent engineers are willing to provide the expedited service within normal working time and outside working hours, determining whether the patent engineer with current working arrangements can complete within the normal working time. If can, the prompt information is generated, which has the patent engineer, the time of complication of the case, and the expedited fee of the case. If cannot, determining whether the patent engineer with current working arrangements can complete within the normal working time added outside working hours based on the working efficiency. If can, the prompt information is generated, which has the services of the patent engineer, the time of complication of the case, and the expedited fee of the case. If cannot, the user may request to recommend other patent engineers that may satisfy the user request.

Or, if the method got to the patent engineers are willing to provide the expedited service within normal working time and outside working hours, determining whether the patent engineer with current working arrangements can complete without using the normal working time. If can, the prompt information is generated, which has the services of the patent engineer, the time of complication of the case, and the expedited fee of the case. If cannot, determining whether the patent engineer with current working arrangements can complete within the normal working time added outside working hours based on the working efficiency. If can, the prompt information is generated, which has the services of the patent engineer, the time of complication of the case, and the expedited fee of the case. If cannot, the user may request to recommend other patent engineers that may satisfy the user request.

Of course, it will be understood that variety of suggestions can be provided for the user, such as a view from the cost. When the patent engineer may provide expedited service within both in the normal working time the additional working hours, the feedback is based on the time cost or the money cost for the user.

Or, if the method got to the patent engineers are willing to provide the expedited service only within outside working hours, determining whether the patent engineer with current working arrangements can complete before deadline. If can, the prompt information is generated to prompt the user to select the patent engineer to provide an expedited service. If cannot, the user may request to recommend other patent engineers that may satisfy the user request.

Furthermore, in some embodiments of the present invention, in the selecting method, determining whether the patent engineer is willing to provide the expedited service, in a manner that sending an advisory opinion to the corresponding patent engineer and basing on the reply of the patent engineer.

The patent engineer database may not have expedited service information of the patent engineer who only not meet the requirements of the deadline. So the user can send an advisory opinion to the corresponding patent engineer through the input device. And the patent engineer reply whether can provide expedited service by another input device to the user. If can, the user inputs the feedback order through the input device to confirm communication between the user and the patent engineer. If can not, the user can re-input condition for matching or the patent engineer might meet the needs is recommended to the user.

Furthermore, the selecting method comprises the following steps of:

if there is no patent engineer matched, determining whether there is a patent engineer with only the deadline of the case is not met;

if so, generating a prompt information, wherein the prompt information is output as at least part of the matching result;

sending an inquiry message to the patent engineer;

feedbacking a reply of patent engineer to the user; and

receiving the feedback order from the user.

Furthermore, the selecting method may further comprise the following steps:

if there is no patent engineer matched, analyzing the user request to derive an analysis result; and

matching at least one of patent engineer to derive the matching result, based on the analysis result.

Specifically, when the user request cannot be satisfied one by one, the user request is analyzed to determine the core of the user's needs to be satisfied by some of other patent engineers.

For example, a user input the name A of one patent engineer through the input device, wherein the patent engineer A is a senior engineer and has experience of optical cases. But the normal working hours and additional work hours of the patent engineer A have been filled up, so he cannot provide patent services for the user. After analyzing the background of the patent engineer A, a similar patent engineer B is matched, who is a senior engineer and has experience of optical cases, and the patent engineer B is capable of completing the case of the user in time. The patent engineer B is output as at least part of the matching result to the user for considering.

Furthermore, it is worth to be mention that not only can the service object select the service provider, the service provider can also select the service object.

The bidirectional selecting method 1 comprises the following steps:

after obtaining an expression data about a service provider, acquiring at least one intentional object in a service object database to obtain a processing result based on the expression data and a background information of the service provider; and

outputting the processing result.

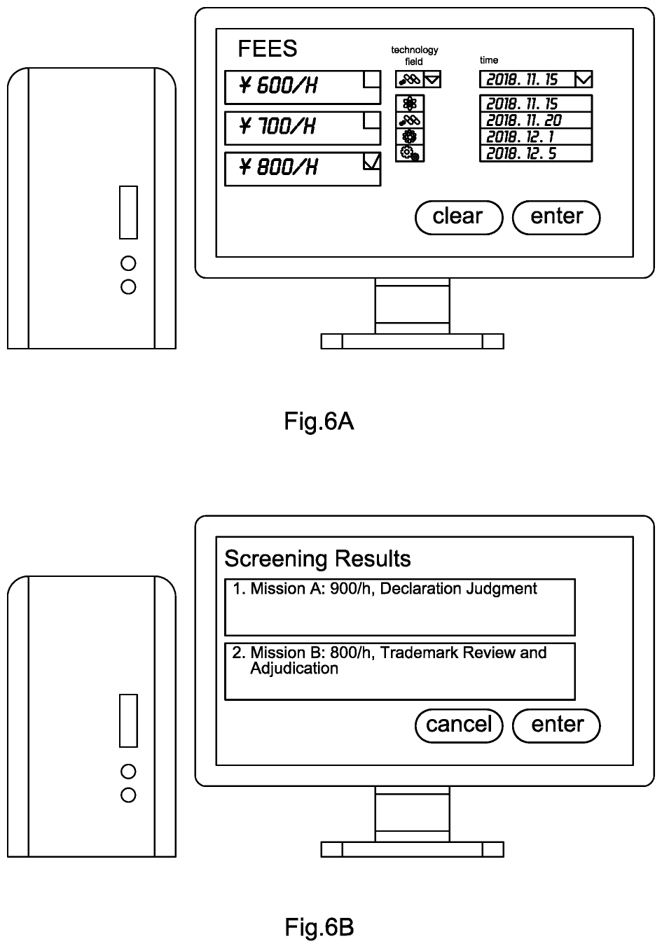

As shown in FIGS. 6A and 6B, illustrating between the lawyer and the client. The lawyer can input a request based cost and/or time and/field the conditions, such as the cost over $800/h and the field of intellectual property. Based on the request of the lawyer as the expression data a search may be performed in the client case database, and the search result is: a case A, $900/h, on invaliding a patent, and a case B, $800/h, about trademark.

The layer can select cases based on his or her own needs.

It is understood that when the expression data of the service provider is directly based as conditions to screen results, the client or the case as the potential intentional object is recommended to the lawyer.

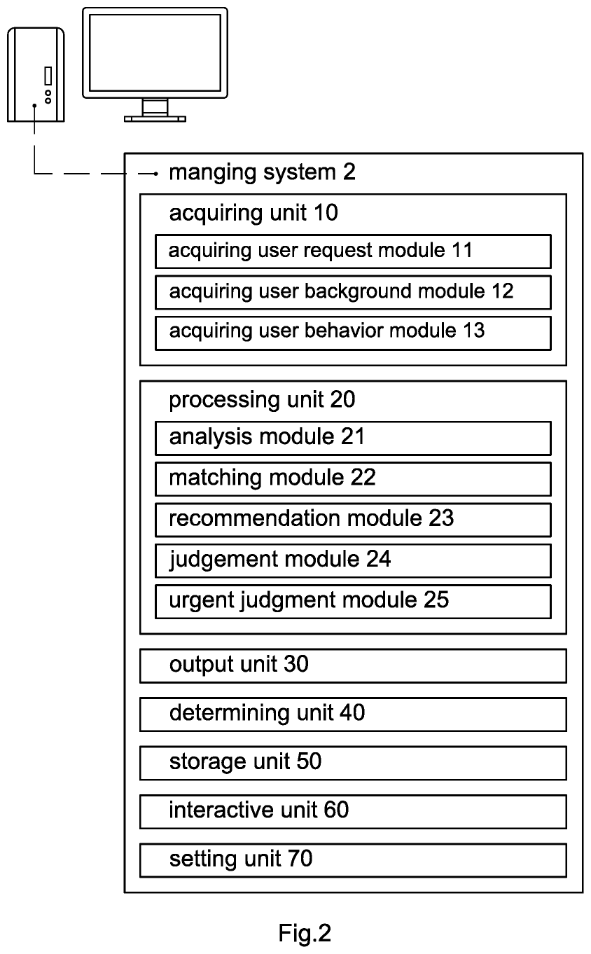

According to another aspect of the present invention, as shown in FIG. 2, the present invention provides a bidirectional selecting system 2 between the service object and the service provider, wherein the system 2 comprises an acquiring unit 10, a processing unit 20, an output unit 30 and a determining unit 40, wherein the acquiring unit 10 is communicably connected with the processing unit 20, and the output unit 30 being communicably connected with the processing unit 20, and the determining unit 40 is communicably connected with the output unit 30.

The acquiring unit 10 is configured to receive at least one of the user request. The processing unit 20 processes the user request to obtain a processing result based an object database. The output unit 30 outputs the processing result which comprises at least one intentional object. The determining unit 40 confirms at least one objects in the object database for the user based on the processing unit 20.

Furthermore, the bidirectional selecting system 2 between the service object and the service provider further comprises a storage unit 50, wherein the storage unit 50 is communicably connected with the processing unit 20, and the object data may be stored in the storage unit 50. The processing unit 20 processes the user request to obtain a processing result based on the object database in the storage unit 50.

The storage unit 50 may also be communicably respectively connected with the acquiring unit 10 and the docking unit. And the storage unit 50 may be configured to store the user request received by the acquiring unit 10. The storing unit 50 can also be used to store a determining result generated by the determining unit 40 as a historical data.

It is worth to mention that the acquiring unit 10 is not only capable of being used for acquiring the user request, but also can obtain a background information of the user, such as the user identity. The processing unit 20 generates one of the processing result based on the user identity acquired by the acquiring unit 10 and the historical data stored in the storage unit 50. For example, according to the patent engineer the user once selected, making recommendations when the user needs to be offered a patent service.

The acquiring unit 10 comprises an acquiring user request module 11 and an acquiring user background module 12, wherein the acquiring user request module 11 and the acquiring user background module 12 are respectively communicably connected with the processing unit 20.

The processing unit 20 comprises an analysis module 21 and a matching module 22, wherein the analysis module 21 is communicatively connected with the acquiring user request module 11 of the acquiring unit 10, and the matching module 22 is communicatively connected with the analysis module 21 and the docking unit.

The analysis module 21 is used to analyzes the request and obtain an analysis result based on the user request acquired of the acquiring user request module 11 of the acquiring unit 10. The analysis result comprises at least one matching condition. The analysis result is sent to the matching module 22. The matching module 22 is respectively communicatively connected with the storage unit 50 and the analysis module 21. The matching module 22 screens to obtain a matching result to match the matching condition in the object database based on the analysis result. The matching result is transmitted to the determining unit 40. The docking unit confirms at least one object in the object database based on the matching result.

For example, the acquiring user request module 11 of the acquiring unit 10 acquires the user request, which needs the object to complete the case before December, 2018 and has more than three years work experience. The analysis module 21 processes the user request to obtain the analysis result. The analysis result comprises two of the matching conditions, and one of the matching conditions is deadline of the case, before December, 2018, and another of the matching conditions is work experience, more than three years.

The matching module 22 performs screening in the object database based on the matching conditions and obtains a matching result, and the determining unit 40 confirms at least one of the objects to the user based on the matching result.

Furthermore, the system 2 comprises the output unit 30 communicably connected with the matching module 22 and the docking unit respectively.

The output unit 30 feedbacks the matching result of the matching module 22 to the user. The determining unit 40 confirms at least one of the objects to the user based on determined information.

When the matching result of the matching module 22 meets the requirements of objects in object database, the output unit 30 outputs the matching result.

Furthermore, when the object met is the requirements of objects in object database and the object number is more than one, the feedback unit outputs the matching result and the acquiring unit 10 acquires a message from the user again. The user may select at least one of the objects of the matching results. The determining unit 40 is communicably connected with the acquiring unit 10 and confirms the object to the user based on the information sent by the user.

Furthermore, the matching result of the matching module 22 is that the object is not exist in the object database who met the requirements, the output unit 30 sent the matching result to the user.

When the matching result of the matching module 22 is that the object is not exist in the object database who met the requirements, the processing unit 20 generates a prompt information. The prompt information is used to ask the user to reset the matching condition, such as reducing the matching condition. The output unit 30 sent the matching result and the prompt information to the user.

When the object met is the requirements of objects in object database and the object number is more than one, the processing unit 20 generates a prompt information. The prompt information is used to ask the user to reset the matching condition, such as adding the matching condition. The output unit 30 sent the matching result and the prompt information to the user.

Furthermore, the processing unit 20 comprises a recommendation module 23 communicably connected with the matching module 22. The recommendation module 23 is used to recommend the object in the object database.

When the matching result of the matching module 22 is that the object is not exist in the object database who met the requirements, the recommendation module 23 generate a recommendation result in the object database based on the user request. And the recommendation result is jointly feedback by the feedback unit and the matching result.

For example, the user request is required the object having working experience 5 years or more and is a senior engineer, and having processed cases fielded of electricity. The matching result of the matching module 22 is that the object is not exist in the object database.

The recommendation module 23 generate a recommendation result screened in the object database based on the user request. For example, one object A having working experience 4 years and is a senior engineer, and having processed cases fielded of electricity can be used as the recommendation result.

It can be understood that the recommendation module 23 can filter the objects by reducing or decreasing the matching condition.

In the present invention, when the matching result of the matching module 22 is that the object is not exist in the object database who met the requirements, and the matching condition is plural, the matching module 22 has no suitable objects in screening, so the recommendation module 23 downgrades the screening conditions. For example, reducing one of the screening conditions, like reducing the deadline of Nov. 15, 2018, only based on having working experience 10 years or more and is a senior engineer, to obtain the screening result including a senior engineer A and another senior engineer B. The senior engineer A has working experience of 6 years, can be used to write case after Nov. 14, 2018, is capable of drafting one case in two days. If this engineer is chosen, the deadline can be Nov. 16, 2018. The senior engineer B has working experience of 8 years, can be used to write case after Nov. 15, 2018, is capable of drafting one case in two days. If this engineer is chosen, the deadline can be Nov. 17, 2018.

Furthermore, the recommendation module 23 may also recommend the object in the object database in other manners. The acquiring unit 10 further comprises an acquiring user behavior module 13 for acquiring a behavior data of the user. The behavior data of the user may be the relevant data about the behavior made on an operator interface. For example, when the user interface is the computer screen, the behavior data may be clicking, refreshing, retrieving. Specifically, the behavior data may be a location of clicking, a frequency of clicking, a browsing time, and the like. The recommendation module 23 is communicably coupled to the acquiring user behavior module 13. The recommendation module 23 recommends the object in the object database based on the behavior data acquired by the acquiring user behavior module 13.

Furthermore, the processing unit 20 comprises a judgement module 24 communicatively coupled to the matching module 22. when the matching result of the matching module 22 is that the object is not exist in the object database who met the requirements, judgement module 24 determines whether there is the matching result not met the matching conditions has only one of the matching conditions not met, and generates a determined result, wherein only one of the matching condition is the deadline of the case.

The processing unit 20 further comprises an urgent judgement module 25, wherein the urgent judgement module 25 is used to determine whether the object in the object database can provide the expedited service or not. The urgent judgement module 25 is communicably coupled to the judgement module 24.

When the judgement module 24 obtains the determined result that is there is not any object only the deadline of the case not met. And the output unit 30 feedback the determined result. The output unit 30 generates a prompt information to ask the user to reset the matching conditions. And the output unit 30 feedback the prompt information. The user can reset the matching conditions to match the object in the object database until the object is satisfied.

When the judgement module 24 obtains the determined result that is there is object only the deadline of the case not met. The urgent judgement module 25 determines based on the determined result that there is object only the deadline of the case not met to determine whether the object in the object database can provide the expedited service or not to complete the case in time.

The urgent judgement module 25 is respectively communicatively connected with the judgement module 24 and the acquiring unit 10. The urgent judgement module 25 compares the expedited information of the object with the deadline based on the expedited information of the object in the object database and the deadline in the user request to make sure the object can complete the case in time.

In details, the urgent judgement module 25 may first determine whether the object can provide the expedited service, if not, urgent judgement module 25 obtains the determined result that the object can not complete in time. If so, the urgent judgement module 25 determines whether the object can complete the case in time. If not, urgent judgement module 25 obtains the determined result.

The output unit 30 is may be communication coupled to the urgent judgement module 25, wherein the output unit 30 generates a prompt information based on the determined result of the urgent judgement module 25 based the deadline and the expedited information of the object in the object database. The prompt information may include fee information of the object to provide the expedited service and type information of the expedited service.

Furthermore, the expedited service may include a cut-in style expedited service and a overtime style expedited service. The cut-in style expedited service means that the object has been arranged fully with cases before the deadline but can changes the priority level according to the urgency of the case, such as to deal the case earlier or to insert a new case directly. The overtime style expedited service means that the object is willing to work outside of normal working to time charge fees to complete as possible.

The prompt information of the unit output 30 may include cost and type of the expedited service of selectable expedited services.

Furthermore, the system 2 comprises an interactive unit 60 communicably coupled to the processing unit 20 for communicating between the user and the object directly.

For example, he object database may not provide information about the object is able to provide the expedited service. The user can sent a question to the object by the interactive unit 60 to ask whether the object is willing to provide the expedited service, and the object is feedback through the interactive unit 60.

After the output unit 30 receives determined information form the user, the determining unit 40 communicate the object and the user. In other words, the object is responsible in accordance with the user's requirements of the case.

Furthermore, the managing system 2 comprises a setting unit 70 communicably connected with the storage unit 50. The setting unit 70 is used to the object modify corresponding object information in the storage unit 50. For example, empirical information, whether to provide expedited service information and provide expedited service type information. The object may modify corresponding object information within the database as required. For example, when one case of the object is over, the object can add this case into working experience for reference by the user during the selection process.

It is worth to mention that, for the objects, it can make sure their own work arrangements in the system 2 and schedule arrangements of the cases. The object can also automatically obtain the cases to be processed and the cases that need to be expedited through the system 2.

For the user, the working arrangement in the storage unit 50 of the object can also be viewed to know whether the case is being processed.

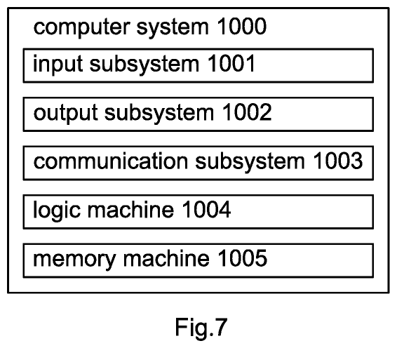

One or more of a computer system 1000 capable of processing the mentioned method is shown in FIG. 7 as non-limiting embodiment. The computer system 1000 is shown in simplified form. The computer system 1000 can be implement in forms of: one or more electronic devices (eg, personal computers, server computers, tablet computers, home entertainment computers, network computing devices, gaming devices, mobile computing devices, mobile communication devices (eg, smart phones) and/or other computing device), an input subsystem 1001, an output subsystem 1002, and a communication subsystem 1003, The input subsystem 1001 may be a mouse or is a keyboard, or a microphone. The output subsystem 1002 may be a display screen or is a broadcast device.

The computer system 1000 comprises a logic machine 1004 and a memory machine 1005. The logic machine 1004 comprises one or more physical devices configured to execute instructions. For example, the logic machine 1004 may be configured to perform as the part of the various commands: one or more applications, services, programs, routines, libraries, objects, components, data structures, or other logical constructs. Such instructions may be implemented to perform tasks, implement data types, convert states of one or more components, effect technical effects, or otherwise achieve desired results.

The logic machine 1004 can be configured to include one or more processors executing software instructions. As a supplement or alternatively, the logic machine 1004 may be configured to execute hardware or firmware instructions as the one or more hardware or firmware logic machines 1004. The processor of the logic machine 1004 can be a single core or a multi-core, and the instructions executed thereon can be configured for serial, parallel, and/or distributed processing. The various components of the logic machine 1004 may optionally be distributed in two or more separated device, and the devices may be remotely located and/or configured to perform co-processing. The logic machine 1004 may be virtualized and executed by a remotely accessible networked computing device configured in a cloud computing configuration.

The memory machine 1005 comprises being configured to save may be made to the logic unit 1004 executed to implement the herein described methods and processes as the machine of one or more physical devices readable instructions. In implementing this method and process, the state of the memory machine 1005 can be transformed (e.g., to store different data).

The memory machine 1005 can comprise some removable and/or built-in devices. The memory machine 1005 may comprise optical storage (eg, CD, DVD, HD-DVD, Blu-ray Disc, etc.), semiconductor memory (eg, RAM, EPROM, EEPROM), and/or magnetic storage (eg, a hard drive, a floppy disk drive, tape drive, an MRAM, etc.) and the like. The memory machine 1005 can comprise volatile, non-volatile, dynamic, static, read/write, read-only, random access, location addressable, file addressable, and/or content addressable devices.

It can be understood that the memory machine 1005 comprises one or more physical devices. However, as described herein, instructions of each of the aspects may alternatively not be held by help of physical devices in a limited duration of communication medium (e.g., an electromagnetic signal, an optical signal, etc.) to propagate.

The logic machine 1004 and the memory machine 1005 can be integrated together into one or more hardware logic components. These hardware logic components may comprise field programmable gate arrays, and applications designed using inheritance circuit, and application-specific standard products, on-chip systems, and complex programmable logic devices.

The output subsystem 1002 can be used to present a visual representation of data held by the memory machine 1005. The visual representation may take the form of a graphical user interface (GUI). Since the data held by the memory machine 1005 described methods and processes herein changes, and thereby transforming the state of the memory machine 1005, and the same as the underlying data changes can be converted to the state of the output subsystem 1002 indicated visually. The output subsystem 1002 can comprise one more display devices, such as a display. It may be such a display device and the logic machine 1004 and/or the memory machine 1005 are combined in a shared package, or such display device may be a peripheral display device.

Including the input subsystem 1001, the input subsystem 1001 can comprise one or more user interface input devices such as mouse, keyboard, or touchscreen. The communication sub system 1003 comprising the input sub system 1001 can be configured to couple with computing system or a plurality of other computing devices. The communication subsystem 1003 may comprise of one or more different communication protocols compatible with the wired and/or wireless communication device. As a non-limiting example, the communication subsystem 1003 can be configured to communicate via a wireless telephone network or a wired or wireless local area wide area network or a ion network. In some embodiments, the communication subsystem 1003 may allow the computer system 1000 to send messages to and/or receive messages from other devices via a network such as the Internet.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention comprises all modifications encompassed within the spirit and scope of the following claims.

What is claimed is:

1. A bidirectional selecting method, between service objects and service providers, comprising the steps of:
after acquiring an expression data about a user, acquiring at least intentional object in a corresponding object database based on the expression data and a background information of the user to obtain a processing result; and
outputting the processing result, wherein when the user is a service object, the object database is a service provider database, wherein when the user is a service provider, the object database is a service object database.

2. The bidirectional selecting method as recited in claim 1, wherein after acquiring the expression data of the user, matching the expression data with the conditions inside the background information of the user in the object database.

3. The bidirectional selecting method as recited in claim 1, further comprising the steps of:
after acquiring the expression data of the user, matching the expression data with the conditions inside the background information of the user in the object database; and
if no intentional object is matched, recommending at least one object in the object database as the intentional object based on the background information of the user.

4. The bidirectional selecting method as recited in claim 1, further comprising the steps of:
after acquiring the expression data of the user, matching the expression data and the conditions included in the background information of the user in the object database; and
if no intentional object is matched, recommending at least one object in the object database as the intentional object based on a behavior information of the user.

5. The bidirectional selecting method as recited in claim 1, further comprising the step of:
obtaining a determined order from the user to confirm that the intentional object is a intentional object.

6. The bidirectional selecting method as recited in claim 3, wherein when the user is a service object and the intentional object is the service provider, further comprises determining whether there is an object with only the deadline of the task is not met and the object is capable of completing the task within the deadline; and
if so, generating a prompt information, wherein the prompt information and the object are output as the processing result.

7. The bidirectional selecting method as recited in claim 4, wherein when the user is a service object and the intentional object is a service provider, further comprises determining whether there is an object with only the deadline of the task is not met but is available for expedited task and the object is capable of completing the task within the deadline; and
if so, generating a prompt information, wherein the prompt information and the object are output as the processing result.

8. The bidirectional selecting method as recited in claim 4, further comprising the steps of:
if the intentional object is not matched, obtaining the behavior data of the user;
generating an intentional prediction result based on the behavior data;
recommending at least one object in the object database is as the intentional object, based on the intentional prediction result.

9. The bidirectional selecting method as recited in claim 7, wherein determining whether the object is capable of providing the expedited service in a manner that obtaining the information of the expedited service predetermined by the service provider.

10. The bidirectional selecting method as recited in claim 7, wherein determining whether the object is capable of providing the expedited service in a manner that obtaining a working arrangement of the object which only not comply with the mandate.

11. The bidirectional selecting method as recited in claim 7, wherein determining whether the object is capable of providing the expedited service in a manner that sending a query to the corresponding object and considering the reply of the object.

12. A bidirectional selecting system, for a service object and a service provider, comprising:
an acquiring unit, wherein the acquiring unit is configured to acquire an expression data and a background information of a user;
a processing unit, wherein the processing unit is communicatively connected with the acquiring unit, wherein the processing unit is configured to have at least one intentional object to obtain a processing result based on an object database with the expression data and the background information of the user; and
an output unit, wherein the output unit is communicably coupled to the processing unit, wherein the output unit outputs the processing result including the intentional object, wherein when the user is service object, the object database is a service provider database, wherein when the user is a service provider, the object database is a service object database.

13. The bidirectional selecting system as recited in claim 12, wherein the system further comprises a determining unit, wherein the determining unit is communicatively connected with the processing unit, wherein the determining unit confirms the object as an intentional object of the user based on a feedback order corresponding to the processing result.

14. The bidirectional selecting system as recited in claim 12, wherein the processing unit comprises an analysis module and a matching module, wherein the analysis module obtains at least one condition based on the analyzed expression data, wherein the matching module matches the object in the object database based on the condition.

15. The bidirectional selecting system as recited in claim 14, wherein the processing unit further comprises a recommendation module, wherein recommendation module is communicatively connected with the matching module, wherein when the matching module has not matched an object in the object database, the recommendation module screens at least one object to obtain a recommendation result based on the expression data of the user according to a predetermined rule in the object database, wherein the recommendation result is output by the output unit.

16. The bidirectional selecting system as recited in claim 15, wherein the recommendation module screens in the object database in a manner that reducing the number of the conditions or reducing the condition.

17. The bidirectional selecting system as recited in claim 12, wherein the acquiring unit comprises an acquiring user request module, an acquiring user background module and an acquiring user behavior module, wherein the processing unit is communicatively connected respectively to the acquiring user request module, the acquiring user background module and the acquiring user behavior module, wherein the processing unit comprises a recommendation module, wherein the recommendation module is communicably connected with the acquiring user behavior module, wherein the recommendation module recommends at least one intentional object from the object database based on a behavior data acquired by the acquiring user behavior module

18. The bidirectional selecting system as recited in claim 17, wherein the processing unit further comprises an analysis module and a matching module, wherein the analysis module obtains at least one condition based on the analyzed expression data, wherein the matching module matches the object in the object database based on the condition, wherein the matching module matches the object based on the object database including the condition, wherein when the matching module has not match the object in the object database, the recommendation module recommends at least one of the intentional object from the object database based on a behavior data acquired by the acquiring user behavior module.

19. The bidirectional selecting system as recited in claim 14, wherein the processing unit further comprises a judgement module and a re-judgement module, wherein when the matching module has not match the object in the object database, the judgement module determines whether there is an object with only the deadline of the task is not met, if so, the re judgement module determines whether the object who not met the deadline is capable of providing an expedited service and whether is capable of finishing the case in time, if so, the output unit outputs the object.

20. The bidirectional selecting system as recited in claim 12, wherein the system further comprises an interactive unit, wherein the interactive unit is communicatively connected with the processing unit and the output unit, wherein the interactive unit is allowed communication between the user and the object.
